(19) United States
(12) Patent Application Publication
(10) Pub. No.: US 2021/0309881 A1
(43) Pub. Date: Oct. 7, 2021

(54) LOW APPLICATION TEMPERATURE POWDER COATING

(71) Applicant: SWIMC LLC, Cleveland, OH (US)

(72) Inventors: Sandy Zhang, Shanghai (CN); Wilson Xu, Shanghai (CN)

(21) Appl. No.: 17/353,571

(22) Filed: Jun. 21, 2021

Related U.S. Application Data
(63) Continuation of application No. 14/561,419, filed on Dec. 5, 2014.
Application No. 14/561,419 is a continuation of application No. PCT/US2013/030994, filed on Mar. 13, 2013.
(60) Provisional application No. 61/659,176, filed on Jun. 13, 2012.

(51) Int. Cl. C09D 163/00; C09D 5/03; C08G 59/40

(52) U.S. Cl. CPC C09D 163/00; C08G 59/4035; C09D 5/03

(57) ABSTRACT

Powder coating compositions that include an epoxy resin composition and a curing agent are described. The powder coating compositions can be applied at low application temperatures of about 165° C. to 185° C. The coating compositions can be used to form fusion-bonded single layer and dual-layer epoxy pipe coatings, and demonstrate optimal corrosion resistance and flexibility with reduced cathodic disbondment.

### CROSS REFERENCE TO RELATED APPLICATION

This application is a continuation of U.S. patent application Ser. No. 14/561,419, filed Dec. 5, 2014, which is a continuation of International Application No. PCT/US2013/030994, filed Mar. 13, 2013, which claims priority from U.S. Provisional Application Ser. No. 61/659,176, filed Jun. 13, 2012, each of which is incorporated herein by reference in its entirety.

### BACKGROUND OF THE INVENTION

Powder coatings are solvent-free, 100% solids coating systems that have been used as low VOC and low cost alternatives to traditional liquid coatings and paints.

Pipelines are generally made with high grade steel with large pipe diameters. The pipelines are coated with corrosion-resistant powder compositions, but conventional pipe coatings have to be cured at temperatures of 200° C. to 230° C., resulting in increased stress, reduced ductility and reduced strength of the high grade steel pipe. Moreover, during transport of fluids such as oil and natural gas, coating flexibility and adhesion deteriorate and the protective coatings tend to peel off the pipe surface.

From the foregoing, it will be appreciated that what is needed in the art is a powder coating composition that can be cured at lower temperatures, thereby providing corrosion protection to high grade steel pipes, and reducing possible cathodic disbondment relative to conventional pipe coatings. Methods for preparing such powder compositions are disclosed and claimed herein

### SUMMARY OF THE INVENTION

The present invention describes powder coating composition that cure at low application temperatures, and methods of coating an article with such compositions are also described.

In one embodiment, the powder coating composition described herein includes an epoxy composition and a curing agent. When combined, the epoxy composition and the curing agent form a powder coating composition that cures at a temperature of about 175° C. to 185° C. within two minutes.

In another embodiment, a method to coat an article is described herein, including the steps of providing an epoxy composition and a curing agent, and combining the epoxy composition and the curing agent to form a powder coating composition. The method further includes steps of applying the powder coating composition to a substrate and curing the powder coating composition at about 165° C. to 185° C. within two minutes.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

The details of one or more embodiments of the invention are set forth in the accompanying drawings and the description below. Other features, objects, and advantages of the invention will be apparent from the description and drawings, and from the claims.

### Selected Definitions

Unless otherwise specified, the following terms as used herein have the meanings provided below.

As used herein, the term “organic group” means a hydrocarbon group (with optional elements other than carbon and hydrogen, such as oxygen, nitrogen, sulfur, and silicon) that is classified as an aliphatic group, cyclic group, or combination of aliphatic and cyclic groups (e.g., alkaryl and aralkyl groups). Organic groups as described herein may be monovalent, divalent or polyvalent. The term “aliphatic group” means a saturated or unsaturated linear or branched hydrocarbon group. This term is used to encompass alkyl, alkenyl, and alkynyl groups, for example. The term “alkyl group” means a saturated linear or branched hydrocarbon group including, for example, methyl, ethyl, isopropyl, t-butyl, heptyl, dodecyl, octadecyl, amyl, 2-ethylhexyl, and the like. The term “alkenyl group” means an unsaturated, linear or branched hydrocarbon group with one or more carbon-carbon double bonds, such as a vinyl group. The term “alkynyl group” means an unsaturated, linear or branched hydrocarbon group with one or more carbon-carbon triple bonds. The term “cyclic group” means a closed ring hydrocarbon group that is classified as an alicyclic group or an aromatic group, both of which can include heteroatoms. The term “alicyclic group” means a cyclic hydrocarbon group having properties resembling those of aliphatic groups. The term “Ar” refers to a divalent aryl group (i.e., an arylene group), which refers to a closed aromatic ring or ring system such as phenylene, naphthylene, biphenylene, fluorenylene, and indenyl, as well as heteroarylene groups (i.e., a closed ring hydrocarbon in which one or more of the atoms in the ring is an element other than carbon (e.g., nitrogen, oxygen, sulfur, etc.)). Suitable heteroaryl groups include furyl, thienyl, pyridyl, quinolinyl, isoquinolinyl, indolyl, isoindolyl, triazolyl, pyrrolyl, tetrazolyl, imidazolyl, pyrazolyl, oxazolyl, thiazolyl, benzofuranyl, benzothiophenyl, carbazolyl, benzoxazolyl, pyrimidinyl, benzimidazolyl, quinoxalinyl, benzothiazolyl, naphthyridinyl, isoxazolyl, isothiazolyl, purinyl, quinazolinyl, pyrazinyl, 1-oxidopyridyl, pyridazinyl, triazinyl, tetrazinyl, oxadiazolyl, thiadiazolyl, and so on. When such groups are divalent, they are typically referred to as “heteroarylene” groups (e.g., furylene, pyridylene, etc.).

Substitution is anticipated on the organic groups of the compounds of the present invention. When the term “group” is used herein to describe a chemical substituent, the described chemical material includes the unsubstituted group and that group with 0, N, Si, or S atoms, for example, in the chain (as in an alkoxy group) as well as carbonyl groups or other conventional substitution. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc.

Unless otherwise indicated, a reference to a “(meth)acrylate” compound (where “meth” is bracketed) is meant to include both acrylate and methacrylate compounds.

The term “polycarboxylic acid” includes both polycarboxylic acids and anhydrides thereof.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

Unless otherwise indicated, the term “polymer” includes both homopolymers and copolymers (i.e., polymers of two or more different monomers).

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION OF THE INVENTION

Embodiments of the invention described herein include compositions and methods including an epoxy resin and a curing agent, wherein the epoxy resin and the curing agent are combined to form a powder coating composition that cures at temperatures of about 165° C. to 185° C. within two minutes. The methods described herein include steps for providing an epoxy resin and a curing agent, combining the epoxy resin and the curing agent to form a powder coating combination, and applying the combination to a substrate. The methods further include curing the powder coating composition at temperatures of about 165° C. to 185° C. within two minutes.

In an embodiment, the powder composition described herein is a curable composition that includes at least one polymeric binder. Suitable polymeric binders generally include a film forming resin. The binder may be selected from any resin or combination of resins that provides the desired film properties. Suitable examples of polymeric binders include thermoset and/or thermoplastic materials, and can be made with epoxy, polyester, polyurethane, polyamide, acrylic, polyvinylchloride, nylon, fluoropolymer, silicone, other resins, or combinations thereof. Thermoset materials are suitable for use as polymeric binders in powder coating applications, and epoxies, polyesters and acrylics are preferred.

In a preferred embodiment, the polymeric binder includes at least one epoxy resin composition or polyepoxide. Suitable polyepoxides preferably include at least two 1,2-epoxide groups per molecule. In an aspect, the epoxy equivalent weight is preferably from about 100 to about 4000, more preferably from about 500 to 1000, based on the total solids content of the polyepoxide. The polyepoxides may be aliphatic, alicyclic, aromatic or heterocyclic. In an aspect, the polyepoxides may include substituents such as, for example, halogen, hydroxyl group, ether groups, and the like.

Suitable epoxy resin compositions or polyepoxides used in the composition and method described herein include without limitation, epoxy ethers formed by reaction of an epihalohydrin, such as epichlorohydrin, for example, with a polyphenol, typically and preferably in the presence of an alkali. Suitable polyphenols include, for example, catechol, hydroquinone, resorcinol, bis(4-hydroxyphenyl)-2,2-propane (Bisphenol A), bis(4-hydroxyphenyl)-1,1-isobutane, bis (4-hydroxyphenyl)-1,1-ethane, bis (2-hydroxyphenyl)-methane, 4,4-dihydroxybenzophenone, 1, 5-hydroxynaphthalene, and the like. Bisphenol A and the diglycidyl ether of Bisphenol A are preferred.

Suitable epoxy resin compositions or polyepoxides may also include polyglicydyl ethers of polyhydric alcohols. These compounds may be derived from polyhydric alcohols such as, for example, ethylene glycol, propylene glycol, butylene glycol, 1,6-hexylene glycol, neopentyl glycol, diethylene glycol, glycerol, trimethylol propane, pentaerythritol, and the like. Other suitable epoxides or polyepoxides include polyglycidyl esters of polycarboxylic acids formed by reaction of epihalohydrin or other epoxy compositions with aliphatic or aromatic polycarboxylic acid such as, for example, succinic acid, adipic acid, azelaic acid, sebacic acid, maleic acid, fumaric acid, phthalic acid, tetrahydrophthalic acid, hexahydrophthalic acid, trimellitic acid, and the like. In an aspect, dimerized unsaturated fatty acids and polymeric polycarboxylic acids can also be reacted to produce polyglycidyl esters of polycarboxylic acids.

In an embodiment, the epoxy resin compositions or polyepoxides described herein are derived by oxidation of an ethylenically unsaturated alicyclic compound. Ethylenically unsaturated alicylic compounds are epoxidized by reaction with oxygen, perbenzoic acid, acid-aldehyde monoperacetate, peracetic acid, and the like. Polyepoxides produced by such reaction are known to those of skill in the art and include, without limitation, epoxy alicylic ethers and esters.

In an embodiment, the epoxy resin compositions or polyepoxides described herein include epoxy novolac resins, obtained by reaction of epihalohydrin with the condensation product of aldehyde and monohydric or polyhydric phenols. Examples include, without limitation, the reaction product of epichlorohydrin with condensation product of formaldehyde and various phenols, such as for example, phenol, cresol, xylenol, butylmethyl phenol, phenyl phenol, biphenol, naphthol, bisphenol A, bisphenol F, and the like.

In an embodiment, the powder composition described herein includes one or more epoxy resin compositions or polyepoxides. In an aspect, the epoxy resin composition or polyepoxide is present in an range of about 20 to 90 wt %, preferably about 30 to 80 wt %, more preferably about 40 to 70 wt %, and most preferably about 50 to 60 wt %, based on the total weight of the powder composition.

In an embodiment, the powder composition described herein is a curable composition that includes at least one curing agent. In an embodiment, the curing agent described herein helps achieve a solid, flexible, epoxy-functional powder composition with a cure time on the order of three minutes or less.

In an aspect, the curing agent is selected to be compatible with the epoxy resin composition and operate to cure the powder composition only when melted at the temperature used to cure and apply the powder composition. Therefore, for the low application temperature described herein, the curing agent is selected to have a melting or softening point within the range of application temperature described herein, i.e. about 165° C. to 185° C., preferably 170° C. to 180° C.

In an embodiment, the curing agent described herein includes one or more compositions having the structure shown in Formula (I):

NH₂—NH—C═(O)—[R1-C═(O)]n-NH—NH2 (I)

In an aspect, in Formula (I), R1 is a polyvalent organic radical with 1 to 25 carbon atoms derived from a polycarboxylic acid, and n is 1 or 0. In another aspect, R1 is a divalent organic radical such as, for example, substituted or unsubstituted C1-C25 alkyl, substituted or unsubstituted C2-C10 alkenyl, substituted or unsubstituted C3-C10 cycloalkyl, substituted or unsubstituted C3-C10 cycloalkenyl, substituted or unsubstituted C3-C10 aryl or aralkyl, substituted or unsubstituted C3-C10 heteroaryl, substituted or unsubstituted C2-C10 alkanoic acid or esters thereof, substituted or unsubstituted C2-C10 dioic acids or esters thereof; or substituted C2-C10 alkenoic acid or esters thereof, and n is 1 or 0.

Suitable curing agents of the compound of Formula (I) include dihydrazides prepared by the reaction of carboxylic acid esters with hydrazine hydrate. Such reactions are known to those of skill in the art and produce, for example, carbodihydrazide, oxalic dihydrazide, malonic dihydrazide, ethyl malonic dihydrazide, succinic dihydrazide, glutaric dihydrazide, adipic dihydrazide, pimelic dihydrazide, sebacic dihydrazide, maleic dihydrazide, isophthalic dihydrazide, icosanedioic acid dihydrazide, valine dihydrazide, and mixtures thereof. Of these, adipic acid dihydrazide, sebacic acid dihydrazide, isophthalic dihydrazide, icosanedioic acid dihydrazide, valine dihydrazide are preferred, with sebacic acid dihydrazide particularly preferred.

In an embodiment, the powder composition described herein includes one or more curing agents, preferably acid dihydrazides such as, for example, sebacic dihydrazide. In an aspect, the curing agent is present in a range of about 1 to 3 wt %, preferably about 1.5 to 2.5 wt %, based on the total weight of the powder composition.

In an embodiment, the method described herein includes combining one or more epoxy resin compositions with a curing agent to form a powder coating composition. The powder composition is a fusible composition that melts on application of heat to form a coating film. The powder is applied using methods known to those of skill in the art, such as, for example, electrostatic spray methods, and cured to a dry film thickness of about 200 to about 500 microns, preferably 300 to 400 microns.

In an embodiment, the present invention provides a method for coating a substrate at low temperatures, i.e. temperatures low enough to allow for complete curing of the powder composition without a negative impact on the structural or physical properties of the substrate. Notably, powder coatings of the type described herein are used on oil and natural gas pipelines, i.e. large diameter pipe made from high grade steel. However, the typical application temperature for powder coatings on pipe is high enough to cause strain aging in the pipe, resulting in increased stress and reduced toughness of the steel. Applying and curing the powder coating at low application temperature for corrosion protection of the pipe without adverse impact on the high grade steel.

In an embodiment, the powder composition is preferably applied to the surface of a substrate, preferably a metal substrate, more preferably a high performance steel substrate. The powder composition is applied using methods known to those of skill in the art, such as, for example, electrostatic spray methods. Prior to application of the powder coating, the substrate is typically and preferably degreased and shot blasted, preferably to a depth of about 50 to 70 microns.

In an embodiment, the methods described herein include applying the powder composition described herein to the substrate and curing the composition on the substrate. In an aspect, the powder composition is applied to a substrate by conventional methods such as electrostatic spray, for example. The coated substrate is then heated to the application temperature of about 165° C. to 185° C., preferably 170° C. to allow the powder particles to melt and fuse, followed by curing of the coating at the same temperature for about three minutes.

In another aspect, the substrate is preheated to the application temperature of about 165° C. to 185° C., preferably 170° C., for a period of about 30 to 45 minutes. The powder composition is then applied to the heated substrate, typically by electrostatic spray. The substrate is then baked to a temperature of about 165° C. to 185° C., preferably 170° C. for a period of about three minutes to cure the coating.

Metal substrates, including high grade steel substrates such as pipe, are prone to corrosion. The rate and extent of corrosion is determined by the nature of the substrate and the nature of the environment to which the substrate is exposed. Protective coatings, including powder coatings, for example, are applied to provide a corrosion-resistant surface. One mode of failure for such protective coatings is cathodic disbondment. Without limiting to theory, cathodic disbondment occurs when the electric potential of a substrate metal falls below the corrosion potential, because of an accumulation of hydrogen ions across the surface, for example. This results in faults (or holidays) in the coating, and in extreme cases, in the separation of the coating from the substrate surface. Without limiting to theory, it is believed that cathodic disbondment is accelerated by an increase in temperature, such as for example, during the transportation of hot fluids through high grade steel pipes.

Because cathodic disbondment depends on the interaction of the protective coating with the substrate, measuring the cathodic disbondment provides a test for the long-term performance of a protective coating. Cathodic disbondment is determined by standard tests known to those of skill in the art, including, for example, CSA Z245.20-10, clause 12.8 (Plant-applied External Coatings for Steel Pipe; clause 12.8-24 hour cathodic disbondment), ASTM G80 (Standard Test Method for Specific Cathodic Disbondment of Pipeline Coatings) and ASTM G95 (Standard Test Method for Cathodic Disbondment of Pipeline Coatings (Attached Cell Method)). These standard tests involve using a test sample of coated metal as the cathode in series with a magnesium anode as part of a galvanic cell. The electrolyte is a mixture of various salt solutions such as NaCl, KCl, NaHCO₃, and the like. Before exposure to the electrolyte, holidays are created in the test sample to provide sites for edge corrosion. The samples are tested after 24 hours or 48 hours of exposure to the electrolyte at 65° C., and at 30 days of exposure to the electrolyte at 65° C.

In an embodiment, protective coatings applied to metal substrates such as, for example, high grade steel, are typically applied at temperatures of about 200 to 230° C. to ensure full cure of the coating compositions. However, exposure to temperatures as high as 200° C. tends to increased stress and reduce ductility and toughness of high grade steel.

Therefore, in contravention of conventional practice and industry bias, the methods described herein include steps for applying and curing the powder composition at low application temperatures of 165° C. to 185° C., preferably 170° C. to 180° C. in three minutes or less, preferably in two minutes. Surprisingly, the methods described herein produce fully cured coatings with excellent performance characteristics such as corrosion resistance and flexibility, particularly when applied to pipeline steel. The low application temperature methods described herein produce a cured coating with 30-day cathodic disbondment of about 5 to 11 mm, preferably less than 9 mm, more preferably less than 7 mm.

In an embodiment, the powder coating composition described herein is a fusion-bonded epoxy (FBE) coating. In an aspect, the FBE coating may be used as a low application temperature (LAT) single layer coating. In another aspect, the FBE coating may be used as a primer layer for a dual-layer FBE coating or for a three-layer polyethylene coating (3LPE). In yet another aspect, the powder composition described herein can be used as a LAT abrasion resistant overlay (ARO) for a dual-layer pipe coating. The characteristics of FBE, 3LPE and ARO coatings are established in the industry and known to those of skill in the art.

The powder composition may optionally include other additives. These other additives can improve the application of the powder coating, the melting and/or curing of that coating, or the performance or appearance of the final coating. Examples of optional additives which may be useful in the powder include: pigments, opacifying agents, cure catalysts, antioxidants, color stabilizers, slip and mar additives, UV absorbers, hindered amine light stabilizers, photoinitiators, conductivity additives, tribocharging additives, anti-corrosion additives, fillers, texture agents, degassing additives, flow control agents, thixotropes, and edge coverage additives.

Techniques for preparing powder compositions are known to those of skill in the art. Mixing can be carried out by any available mechanical mixer or by manual mixing. Some examples of possible mixers include Henschel mixers (available, for example, from Henschel Mixing Technology, Green Bay, Wis.), Mixaco mixers (available from, for example, Triad Sales, Greer, S.C. or Dr. Herfeld GmbH, Neuenrade, Germany), Marion mixers (available from, for example, Marion Mixers, Inc., 3575 3rd Avenue, Marion, Iowa), invertible mixers, Littleford mixers (from Littleford Day, Inc.), horizontal shaft mixers and ball mills. Preferred mixers would include those that are most easily cleaned.

Powder coatings are generally manufactured in a multi-step process. Various ingredients, which may include resins, curing agents, pigments, additives, and fillers, are dry-blended to form a premix. This premix is then fed into an extruder, which uses a combination of heat, pressure, and shear to melt fusible ingredients and to thoroughly mix all the ingredients. The extrudate is cooled to a friable solid, and then ground into a powder. Grinding conditions are typically adjusted to achieve a powder median particle size that is determined by the particular end use for the powder composition.

The epoxy resin composition and curing agent described herein are dry mixed together with any optional additives, and then typically melt blended by passing through an extruder. The extruder typically has one or more zones, and by controlling the temperature within a zone, it is possible to control the properties of the powder coating. For example, the first zone temperature is about 40° C. to 80° C., preferably 50° C. to 70° C., with a second zone at a temperature of about 50° C. to 90° C., preferably 60° C. to 80° C. The resulting extrudate is then solidified by cooling, and then ground to form a powder. Other methods may also be used. For example, one alternative method uses a binder that is soluble in liquid carbon dioxide. In that method, the dry ingredients are mixed into the liquid carbon dioxide and then sprayed to form the powder particles. If desired, powders may be classified or sieved to achieve a desired particle size and/or distribution of particle sizes.

The resulting powder is at a size that can effectively be used by the application process. Practically, particles less than 10 microns in size are difficult to apply effectively using conventional electrostatic spraying methods. Consequently, powders having median particle size less than about 25 microns are difficult to electrostatically spray because those powders typically have a large fraction of small particles. Preferably the grinding is adjusted (or sieving or classifying is performed) to achieve a powder median particle size of about 25 to 150 microns, more preferably 30 to 70 microns, most preferably 30 to 50 microns.

Optionally, other additives may be used in the present invention. As discussed above, these optional additives may be added prior to extrusion and be part of the base powder, or may be added after extrusion. Suitable additives for addition after extrusion include materials that would not perform well if they were added prior to extrusion; materials that would cause additional wear on the extrusion equipment, or other additives.

Other preferred additives include performance additives such as rubberizers, friction reducers, and microcapsules. Additionally, the additive could be an abrasive, a heat sensitive catalyst, an agent that helps create a porous final coating, or that improves wetting of the base powder.

The powder composition described herein may be applied to an article by various means including the use of fluid beds and spray applicators. Most commonly, an electrostatic spraying process is used, wherein the particles are electrostatically charged and sprayed onto an article that has been grounded so that the powder particles are attracted to and cling to the article. After coating, the article is heated. This heating step causes the powder particles to melt and flow together to coat the article. Optionally, continued or additional heating may be used to cure the coating. Other alternatives such as UV curing of the coating may be used.

The powder coating described herein is then cured and such curing may occur via continued heating, subsequent heating, or residual heat in the substrate. In another embodiment of the invention, if a radiation curable powder coating base is selected, the powder can be melted by a relatively short or low temperature heating cycle, and then may be exposed to radiation to initiate the curing process. One example of this embodiment is a UV-curable powder. Other examples of radiation curing include using UV-vis, visible light, near-IR, IR and e-beam.

Preferably, the coated substrate has desirable physical and mechanical properties, including optimal performance properties such as, for example, corrosion resistance, flexibility and the like. Typically, the final film coating will have a thickness of about 100 to 600 microns, preferably about 200 to 500 microns, more preferably about 300 to 400 microns.

The following examples are offered to aid in understanding of the present invention and are not to be construed as limiting the scope thereof. Unless otherwise indicated, all parts and percentages are by weight.

### EXAMPLES

The invention is illustrated by the following examples. It is to be understood that the particular examples, materials, amounts, and procedures are to be interpreted broadly in accordance with the scope and spirit of the inventions as set forth herein. Unless otherwise indicated, all parts and percentages are by weight and all molecular weights are weight average molecular weight.

### Test Methods

Unless indicated otherwise, the following test methods were utilized in the Examples that follow.

Cathodic Disbondment

The corrosion resistance of the powder coating is determined by cathodic disbondment testing, performed according to ASTM G80 or ASTM G95 testing (Standard Test Method for Specific Cathodic Disbondment of Pipe Coating).

How Water Adhesion Test

Hot water adhesion testing is performed to assess whether the coating adheres to the coated substrate. Test samples coated with the powder composition are immersed in hot water baths maintained at 95° C. for 30 days. The test samples are then removed and while still warm, scribed with a 30×15 mm rectangle through the coating to the substrate. Within one hour of removal from the hot water bath, the tip of a utility knife is inserted under the coating at a corner of the scribed rectangle to remove the coating or to assess the coating's resistance to removal. The adhesion of the coating is rated on a scale of 1 to 5, where a rating of 1 indicates a coating that cannot be cleanly removed and a rating of 5 indicates a coating that can be completely removed in one piece.

Flexibility/Bending Test

This test provides an indication of a level of flexibility of a coating and an extent of cure. For the test described herein, coated test strips (25×200×6.4 mm) are prepared and evaluated. The test strips are cooled to −30±3° C. and held at that temperature for a minimum of one hour. The thickness of the test strip is determined by laying the strip on a flat surface and used to calculate the mandrel radius needed for the bend test. A 3°/PD (pipe diameter) bend is made, lasting not longer than 10 s and completed within 30 s of the test strip being removed from the freezer. The bent test strip is then warmed to 20±5° C. and held at that temperature for a minimum of two hours. Within the next hour, the test strips are visually inspected for failure, with failure demonstrated by cracks or fractures in the coating surface.

### Example 1

A raw material mixture containing 60 parts by weight of an epoxy resin composition and 2-3 parts by weight of a sebacic dihydrazide curing agent is prepared. Cure accelerators, flow control agents and pigments are added to the raw material mixture and the combination is fed into a powder coating premixer. After mixing for three minutes, the premix is extruded with a powder extruder having two zones. The temperature in the first zone is maintained at 50−70° C., with the second zone maintained at 60−80° C. After extrusion, the extrudate is ground with chips in a powder grinder to adjust the particle size. The coating composition is then applied to test panels and cured at a temperature of 170° C. for two minutes. For comparison purposes, a commercially available powder composition is applied to test panels and cured at a temperature of 190° C. for five minutes. Test results are shown in Table 1.

TABLE 1
Comparison of Key Performance Characteristics

| | Type of Coating | |
|---|---|---|
| | Example 1 | Comparative Example |
| Application/Cure Conditions | 170° C. for 3 min; 99% cure | 190° C. for 5 min; 99% cure |
| Cathodic Disbondment Test | 8 to 11 mm | 18 to 21 mm |
| (65° C., 1.5 V, 30 days) | | |
| Hot Water Adhesion | 1 (pass) | 4 (fail) |
| (95° C., 30 days) | | |
| Flexibility (−30° C., 3°/PD) | No cracking | Cracking |

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

What is claimed is:

1. A method of protecting a metal article from corrosion and improving cathodic disbondment resistance, comprising:
providing a steel article comprising at least a portion of a pipe or pipeline for transport of oil or gas, wherein the article is preheated to a temperature of 165° C. to 185° C.;
applying a powder coating composition to a surface of the preheated article, the composition comprising:
about 40 to 70 wt % of an epoxy resin composition comprising an epoxy ether formed by a reaction of ingredients including an epihalohydrin and a polyphenol; and
about 1 to 3 wt % of a curing agent, wherein the curing agent has the structure of formula I:
NH₂—NH—C═(O)—[R¹—C═(O)]ₙ—NH—NH₂ (I)
wherein R¹ is a polyvalent organic radical derived from a carboxylic acid; and n is 1 or 0; and
baking the article with the powder coating composition applied thereon for up to three minutes to form a fully cured corrosion-resistant film with dry film thickness of about 200 to 500 microns on the surface of the article,
wherein the powder coating composition has a cathodic disbondment when cured of less than 11 mm, as determined by ASTM G-95.

2. The method of claim 1, wherein R¹ comprises substituted or unsubstituted C1-C20 alkyl; substituted or unsubstituted C2-C10 alkenyl; substituted or unsubstituted C3-C10 cycloalkyl; substituted or unsubstituted C3-C10 cycloalkenyl; substituted or unsubstituted C3-C10 aryl or aralkyl; substituted or unsubstituted C3-C10 heteroaryl; substituted or unsubstituted C2-C10 alkanoic acid or esters thereof substituted or unsubstituted C2-C10 dioic acids or esters thereof; or substituted C2-C10 alkenoic acid or esters thereof.

3. The method of claim 1, wherein the curing agent is selected from the group consisting of carbodihydrazide, oxalic dihydrazide, malonic dihydrazide, ethyl malonic dihydrazide, succinic dihydrazide, glutaric dihydrazide, adipic dihydrazide, pimelic dihydrazide, sebacic dihydrazide, maleic dihydrazide, isophthalic dihydrazide, icosanedioic acid dihydrazide, valine dihydrazide, and mixtures thereof.

4. The method of claim 1, wherein the curing agent is selected from the group consisting of adipic acid dihydrazide, sebacic acid dihydrazide, isophthalic dihydrazide, icosanedioic acid dihydrazide, valine dihydrazide, and mixtures thereof.

5. The method of claim 1, wherein the curing agent is sebacic dihydrazide.

6. The method of claim 1, wherein the epoxy resin and the curing agent are combined to form a fusion bonded epoxy.

7. The method of claim 1, wherein the epoxy resin has an epoxy equivalent weight of about 100 to about 4000.

8. The method of claim 1, wherein the epoxy resin composition has an epoxy equivalent weight of about 500 to about 1000.
